(19) United States
(12) Patent Application Publication
(10) Pub. No.: US 2003/0084287 A1
(43) Pub. Date: May 1, 2003

(54) System and method for upper layer roaming authentication

(76) Inventors: Huayan A. Wang, (US); Bruce Willins, (US); Rich Vollkommer, (US)

Correspondence Address: Mark I. Koffsky, Esq., Symbol Technologies, Inc., MS A-6, One Symbol Plaza, Holtsville, NY, 11742-1300, US

(21) Appl. No.: 10/026,043

(22) Filed: Oct. 25, 2001

(51) Int. Cl. H04L 9/00

(52) U.S. Cl. 713/168; 380/270

(57) ABSTRACT

A method and system for authenticating a roaming device with a network is described. The roaming device initially is authenticated with an authentication server that sends authentication information to remote access points. When the roaming device enters in contact with one of the access points, a local authentication is performed between the access point and the roaming device to allow the device to access the network.

### FIELD OF THE INVENTION

The present invention relates to method and system for authenticating a roaming device. In particular, the present invention relates to an authentication mechanism for a roaming device using a system other than a Kerberos system.

### BACKGROUND OF THE INVENTION

Many modern devices are able to connect with networks while they are moving, for example to retrieve data or to access services. The devices may be portable computers, hand held computers, or simpler devices such as cellular telephones or electronic mail receivers with a wireless connection to a network. As these devices move about, or roam, they pass through areas assigned to different access points to their network, leaving the area of one access point and entering the area of another. Every time the device roams into the area of a different access point, it must be identified, and the network must ascertain that the device is allowed to access the resources of the network.

This authentication process often is time consuming, and may tie down significant network resources while being carried out. In simple terms, the authentication requires a user of resources to prove its identity before being granted access to a network. There are several existing upper layer authentication protocols that can be used to authenticate roaming devices in a network. One system is Kerberos, a security system for client/server computing developed in the 1980's at the Massachusetts Institute of Technology. Kerberos relies on a trusted key distribution center to issue secure electronic tickets to authenticate users in a distributed system. It allows optimization of roaming performance by allowing all access points to share a common cryptographic key with the roaming device. This allows authentication to take place between the roaming device and the individual access point being contacted, without having to contact a remote authentication server each time the device roams to a new access point.

Another authentication method is the Remote Authentication Dial-hi User Service (Radius). Radius is a client/server authentication software system that supports remote access applications. Radius allows a network to maintain user profiles in a centralized database residing in an authentication server which can be shared by multiple remote access servers, or access points. These remote access servers act as Radius clients, and are connected to the centralized authentication server.

### SUMMARY OF THE INVENTION

Embodiments of the present invention include a method for authenticating a roaming device with a network, comprising generating authentication information associated with the roaming device in an authentication server of the network, sending the authentication information to access points of the network, connected to the authentication server, and locally authenticating the roaming device at the access points using the authentication information.

In another aspect, the invention is a system of authenticating a roaming device with a network. The system includes an authentication server connected to the network, access points connected to the authentication server, each of the access points being adapted to link wirelessly to the roaming device, and cache memories of the access points adapted to store authentication information related to the roaming device. The authentication server sends the authentication information to the access points upon an initial authentication of the roaming device with an access point, and the access points locally authenticate the roaming device upon successive connections with access points, if the authentication information is found.

### BRIEF DESCRIPTION OF THE DRAWINGS

FIG. 1 is schematic diagram showing a roaming device moving among access points of a network connected to an authentication server, according to an embodiment of the present invention;

FIG. 2 is a flow chart describing the authentication process according to an embodiment of the present invention; and

FIG. 3 is a schematic representation of the data exchange between a roaming device and an access point, according to an embodiment of the present invention.

### DETAILED DESCRIPTION

The current standard of security for authentication of wireless devices is based on the IEEE 802.11 architecture, which has several weaknesses. This wired equivalent privacy (WEP) standard improved under the IEEE 802.11 working group devises new solutions to address the shortcomings of the older standard by providing a number of additional security features. These features include enhanced authentication mechanisms for both the access points (AP's) and the stations (STA's) such as the mobile roaming devices. Other features include enhanced key management algorithms, and dynamic, association specific cryptographic keys, also referred to as WEP-session keys. This enhanced standard depends extensively on the IEEE 802.1x protocol, and allows the IEEE 802.11 Media Access Control (MAC) protocol to delegate the authentication functions to upper layer authentication protocols.

Within the framework of IEEE 802.1x, the access point (AP) takes the role of an “authenticator”, tasked with enforcing authentication before allowing access to services of the network. In this scheme, the mobile STA takes the role of “supplicant”, which wishes to access the services or resources offered by the authenticator AP. For example, one service provided may be the AP's packet forwarding functionality. This framework also requires a third party, referred to as the authentication server (AS), that performs the authentication function necessary to check the credentials of the supplicant on behalf of the authenticator. In this manner, the authentication server indicates to the Access point whether the supplicant is authorized to access the resources offered by the authenticator AP.

The authentication server may take different forms, depending on what type of upper layer authentication protocol is utilized. For example, if a Kerberos system is used instead, the AS may be a Key Distribution Center (KDC). If Microsoft's EAP-TLS system is used, the AS may be a Radius Server. In cases where the STA supplicant is a mobile device that roams from access point to access point, a difficulty arises with respect to the Radius Servers used in non-Kerberos based authentication protocols. Since the Radius system uses a centralized database of users, once authentication of the STA supplicant is performed with one Access point, that authentication will not necessarily be valid when the STA supplicant moves to another Access point.

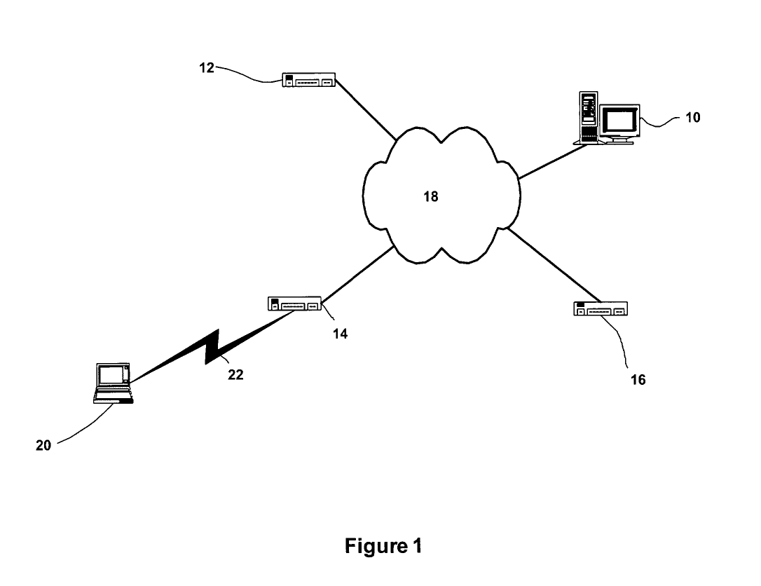

FIG. 1 shows the interconnections of the fixed and mobile elements of a network including roaming devices, according to an embodiment of the present invention. An authentication server 10 is connected to a plurality of access points 12, 14 and 16 through a network 18. In this exemplary embodiment, only three access point are show, however more or fewer Access points may be included in the system. The authentication server 10 may be, for example, a Radius server operating under a non-Kerberos protocol. Network 18 may be a wired network, but in other embodiments may be a wireless or other type of network.

STA supplicant 20 may be one of a variety of mobile devices that are portable and that allow the user to access data or services provided by the network that includes Access points 12-16 and authentication server 10. As shown in FIG. 1, STA supplicant 20 is connected to one of the access points such as Access point 14, for example through a wireless connection 22. As STA supplicant 20 roams, it leaves the area controlled by Access point 14, and may enter an area in which it is in contact with another Access point, for example access points 12 or 16.

The following description of an exemplary embodiment according to the present invention assumes that the authentication server 10 is a Radius server, utilizing a non-Kerberos upper layer authentication protocol. In this case, the STA 20 and the authentication server 10 perform mutual authentication using an EAP-compatible authentication mechanism. For example, a WEP-session key may be generated at both the STA 20 and at the authentication server 10 after a successful authentication. During the authentication process, the Access point 14 simply relays data packets between the STA 20 and the authentication server 10, and does not know the WEP-session key because the “shared secret’ between STA 20 and access server 10 is not divulged to the Access points. The shared secret can be, for example, a password that is only known by the two parties to the transaction.

To continue the authentication process, the authentication server 10 sends the WEP-session key to the access point 14, so that STA 20 may access the network through Access point 14. For example, the WEP-session key may be sent to Access point 14 encrypted, using a shared secret between Access point 14 and the access server 10. In one exemplary embodiment, the WEP-session key may be sent to the Access point as a Vendor Specific Attribute (VSA) in the Radius packet. One drawback of the system described above is that when STA 20 roams, the entire authentication sequence has to be repeated every time a new Access point is accessed. This reduces roaming performance of the system, because information has to make several round trips between STA 20 and the authentication server 10 before access is granted.

In one exemplary embodiment according to the present invention, roaming performance is improved in cases where a non-Kerberos authentication scheme is used. After STA 20 and the authentication server 10 have successfully authenticated as described above, the authentication server 10, which may be a Radius server, delivers the WEP-session key to additional access points within the Extended Service Set (ESS, defined in IEEE 802.11), so that the WEP-session key will be available whenever STA 20 roams from one Access point to another. In a different exemplary embodiment, the WEP-session key is delivered only to a set of Access points to which the STA is likely to roam. Known prediction algorithms may be used to anticipate where the STA 20 is likely to roam. Alternatively, the authentication information including the WEP-session key may be sent to every access point of the network.

According to embodiments of the present invention, when the STA 20 roams into an area served by a new Access point, it initially attempts to perform a local mutual authentication with the new access point using a standard authentication protocol based on a shared secret. For example, the protocol may be MS-CHAP Version 2. If the access point in question has previously received the appropriate WEP-session key from the authentication server 10, the authentication succeeds, and STA 20 is granted access to the network. If for some reason the local authentication fails, the full authentication process between STA 20 and access server 10 is carried out. If the authentication fails at this point, it could indicate that the present access point never received the appropriate WEP-session key from authentication server 10.

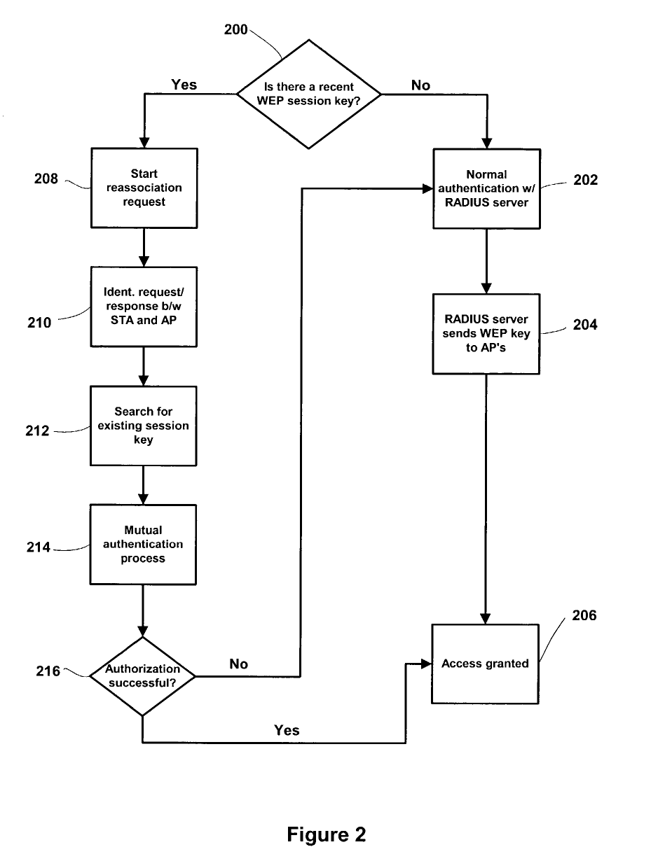

An authentication process according to an exemplary embodiment of the present invention is described in greater detail with reference to FIG. 2. When STA 20 contacts an access point within the ESS for the first time, for example access point 14, there are no active WEP-session keys associated with the STA that will grant access to the network resources. In this case, STA 20 has to perform a preliminary authentication step with the authentication server 10, using any known authentication procedure appropriate to the system used by the network. For example, for a non-Kerberos system such as the Radius system, a conventional Radius authentication with the Radius server can be carried out.

As shown in FIG. 2, step 200 includes a determination whether a WEP-session key has already been generated for STA 20. If not, a conventional authentication with the authentication server 10 is carried out in step 202. After the conventional authentication is completed successfully, the authentication server 10 sends authentication information that includes the WEP-session key so generated to the access point that is currently connected to STA 20, and also to additional access points. Step 204 thus includes sending the authentication information to all access points present in the ESS network, or alternatively, only to a set of access points where the STA 20 is likely to roam.

Several methods may be used to distribute the WEP-session key and associated information to the selected access points. In one exemplary embodiment, all the access points of the ESS can be configured to share a common secret with the authentication server 10, so that the access server 10 can multicast the WEP-session key, together with other identification information, to all the access points. This multicast transmission may be made, for example, by encrypting the WEP-session key using the shared secret known to all access points. All the trusted access points that know the shared secret are then able to decrypt the WEP-session key. In one exemplary embodiment, each access point may save that information in a cache memory for future use. When the STA that originally authenticated with authentication server 10 roams to an access point that previously received the authentication information, the STA may be authenticated locally by the access point using the stored WEP-session key, without having to contact authentication server 10.

Multi casting the authentication information and the WEP-session key to all access points may not be desirable or feasible under certain circumstances. In those cases, according to another exemplary embodiment of the present invention, the authentication server 10 may send multiple unicast data packets, directed individually to each access point in the network, or to selected access points that are likely to accept the roaming STA 20 in the future. As described above, the encrypted WEP-session key can be decrypted by each access point that knows the appropriate shared secret, and may be stored in a cache memory for future use. In one exemplary embodiment, a timeout parameter may be specified along with the WEP-session key, so that access will be granted only for a limited period of time before expiring.

If it is determined in step 200 that an authentication had previously been performed by an initial access point with respect to STA 20, and that a WEP-session key has been previously generated to let STA 20 communicate with that initial access point, the process is directed to step 208. A reassociation request is initiated in step 208 with a new access point to which STA 20 roamed. The reassociation request may include an exchange of identity information between the STA 20 and the new access point, for example in the form of an identity request and an identity response in step 210. Once the identity of the STA is established, in step 212 the access point checks its local cache memory containing the authentication information previously received from authentication server 10, to determine if a valid WEP-session key associated with the STA 20 is present. If the correct WEP-session key is found, the access point begins a mutual authentication process to insure that both the access point and the STA hold the same shared secret, or the same WEP-session key.

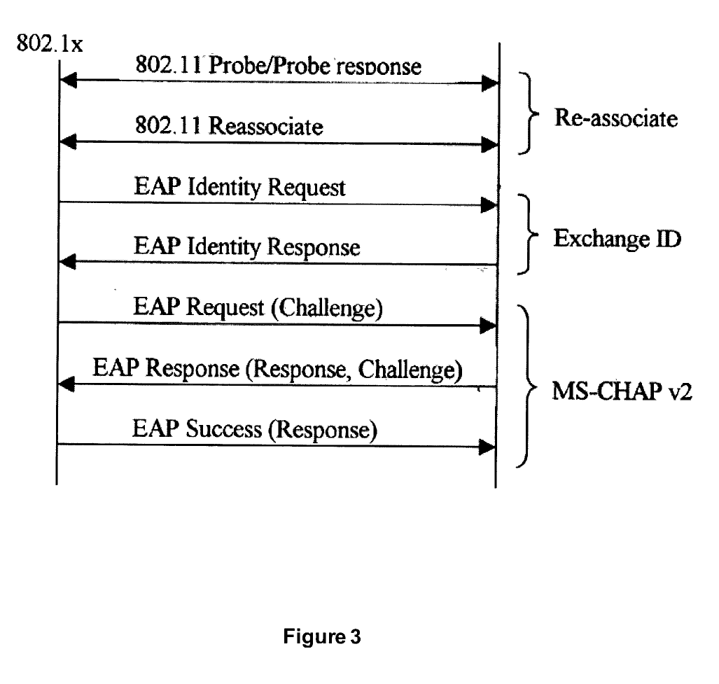

The mutual authentication carried out in step 214 can take many forms. For example, the method described in MS-CHAPv2 (RFC 2759) may be used, however any mutual authentication scheme based on a shared secret may be used for this purpose. This method, shown schematically in FIG. 3, involves the steps of an initial Probe and Probe Response between the STA and the AP, and a Reassociation. In a further step an exchange of ID's is performed, including an EAP Identity Request and an EAP Identity Response. These two initial steps correspond respectively to steps 208 and 210 of FIG. 2. The actual mutual authentication under MS-CHAPv2 includes an EAP Request (Challenge) and an EAP Response (Response, Challenge), that if successful results in transmittal of an EAP Success (Response) message. In a different exemplary embodiment, a EAP-MD5 method may be used twice, one time from the access point to authenticate the STA, and a second time when the STA authenticates the AP.

Step 216 of the exemplary method of authentication according to the present invention involves evaluating the results of the reassociation request carried out between the new access point and the STA 20. If the reassociation request and the ensuing authorization steps are successful, access is granted in step 206. At that point, STA 20 is allowed to access the resources of the network through the new access point. If the authorization is not successful, STA 20 may be programmed to attempt another reassociation request. This second reassociation request may be, for example, directly with the authentication server 10, and may involve the conventional authentication steps 202 and 204 described above.

According to one exemplary embodiment of the method according to the present invention, the security of the authentication system may be enhanced by periodically updating the WEP-session keys. An abbreviated authentication procedure may be executed at set intervals to update the WEP-session keys of the various STA's that are connected to the network. For example, in an abbreviated authentication procedure the authentication server 10 generates new WEP session keys at configurable time intervals, and sends the keys to the Access Points 12, 14, 16, to the STA 20, and to any additional STA's or AP's present in the network. The WEP session keys are encrypted using the respective shared secrets, or passwords, for each of the STA's and AP's. In this example, the STA roaming device 20 and the AP's 12, 14, 16 switch to the new WEP session key simultaneously, based on a common protocol. For example, the common protocol may specify that the WEP session key is changed after 100 data packets are encrypted with the key.

In a different exemplary embodiment according to the present invention, the procedure for using the WEP-session key may be changed to increase security of the system. If the encryption key is used repeatedly, the security of the entire system may be reduced. Accordingly, after an STA is authenticated, the authentication server may multicast to all or to selected ones of the access points a key pair rather than only a single WEP-session key. The key pair may include, for example, a WEP-authentication key and a WEP-session key. Under this system, the WEP-session key is used for local authentication only.

According to the exemplary embodiments discussed, the authentication server 10 can generate a WEP session key that is used for both local authentication when the roaming device 20 roams, as well as for encryption of the data exchanged between roaming device 20 and the particular access point to which STA 20 has roamed. (Access point 14 in FIG. 1.) Alternatively, the authentication server 10 can generate a pair of keys: a WEP session key used only for data encryption, and a separate authentication data key used for local authentication when STA roaming device 20 roams. The latter scheme provides greater security, because the encryption key is used repeatedly to encrypt data, and may become compromised more easily. It is therefore advantageous to use another, separate shared secret to use during authentication.

In this context, the shared secret may be a password or other key that is known only by the authorized parties of the transaction. For example, the Radius authentication server and a user having an account with the network have a shared secret, in the form of the user's password. Computers can use a shared secret to authenticate each other, meaning that they prove to each other that they know the password, or they can use the shared secret to derive encryption keys used to encrypt data.

In the exemplary embodiment of the present invention described in FIG. 1, the Radius server (authentication server 10) and the STA roaming device 20 have a shared secret in the form of the password of the user. The shared secret is used to perform the initial mutual authentication between the radius server and the STA 20. Another shared secret may be used between the authentication server 10 and each of the access points 12, 14, 16, to authenticate each other, and to encrypt information passed between them, such as the WEP session key associated with the roaming device STA 20. Once the authentication server 10 authenticates STA 20 upon initial contact, it generates the WEP session key, or other similar secret, to be used as the shared secret between the STA 20 and whichever access point the STA 20 tries to authenticate with. As indicated above, the WEP session key is sent by authentication server 10 to the pertinent access points, which can then use it to authenticate the STA 20 once it roams to them, and to encrypt data exchanged between STA 20 and the access points.

The present invention has been described with reference to an embodiment having one STA roaming device and three access points, of which only one is in use at a given time. However, other embodiments may be devised that include additional STA devices and/or additional or fewer access points. Non-Kerberos systems other than the Radius system may also be used to carry out the authentication of the STA supplicants. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. A method for authenticating a roaming device with a network, comprising the steps of:
generating, by an authentication server of the network, authentication data associated with the roaming device;
sending the authentication data to access points of the network, the access points being connected to the authentication server; and
when the roaming device roams to a particular access point of the access points, using the authentication data to locally authenticate the roaming device at the particular access point.

2. The method according to claim 1, further comprising the step of:
storing the authentication data in a memory arrangement of each of the access points.

3. The method according to claim 1, wherein the sending step includes the substeps of:
encrypting the authentication data; and
sending the encrypted authentication data to selected access points of the access points.

4. The method according to claim 3, wherein the sending step includes the substeps of:
determining at least one access point of the access points where the roaming device is likely to roam; and
sending the encrypted authentication data to the at least one access point.

5. The method according to claim 3, wherein the sending step includes the substep of
sending the encrypted authentication data to all the access points.

6. The method according to claim 1, further comprising the preliminary steps of:
determining if the particular access point has authentication data associated with the roaming device;
if the determination is positive, proceed to the step of using the authentication data to locally authenticate the roaming device at the particular access point; and
if the determination is negative, proceed to the step of generating, by an authentication server of the network, authentication data associated with the roaming device.

7. The method according to claim 6, wherein the step of using the authentication data to locally authenticate the roaming device further comprises reassociating the roaming device with the particular access point of the access points by exchanging identification information.

8. The method according to claim 7, wherein the reassociating step further includes the substeps of:
searching a memory arrangement of the particular access point for the authentication data associated with the roaming device; and
if the authentication data is found, performing a mutual authentication procedure between the roaming device and the particular access point.

9. The method according to claim 1, wherein the generating step further includes the steps of:
receiving an encrypted authentication request from the roaming device;
determining that the roaming device can be granted access to network services; and
generating an encrypted session key associated with the roaming device in the authentication server.

10. A method for authenticating a roaming device with a network, comprising the steps of:
connecting the roaming device with an authentication server upon a contact of the roaming device with a first access point of the network;
authenticating the roaming device with the authentication server;
generating authentication data for the roaming device;
distributing the authentication data to the first access point and a second access point of the network; and
locally authenticating the roaming device upon a contact with the second access point using the distributed authentication data.

11. The method according to claim 10, further comprising the step of:
authenticating the roaming device with the authentication server if the local authentication of the roaming device fails.

12. The method according to claim 10, wherein the distributing step further includes the substep of:
distributing an encrypted session key to the first and second access points.

13. The method according to claim 10, wherein the locally authenticating step further includes the substeps of:
exchanging identification data between the roaming device and the second access point; and
correlating the identification data with the distributed authentication data.

14. The method according to claim 10, further comprising the step of:
establishing a shared secret encryption between the authentication server and the first and second access points.

15. The method according to claim 10, wherein the authentication server is a remote authentication dial-in user server.

16. A system for authenticating a roaming device with a network, comprising:
an authentication server connected to the network; and
first and second access points connected to the authentication server, the first and second access points being capable of communicating with the roaming device, each of the first and second access points including a memory arrangement capable of storing authentication data corresponding to the roaming device,
wherein the authentication server sends the authentication data to the first and second access points upon an initial authentication procedure of the roaming device with the first access point, and
wherein the second access point locally authenticates the roaming device upon a contact of the roaming device with the second access point.

17. The system according to claim 16, wherein the second access point authenticates the roaming device with the authentication server if the authentication data is not found in the memory arrangement of the second access point.

18. The system according to claim 16, wherein the second access point authenticates the roaming device with the authentication server if the local authentication of the roaming device at the second access point fails.

19. A method for authenticating a roaming device with a network, comprising the steps of:
with an authentication server, receiving an authentication request from a roaming device, the request being encrypted with a first shared code;
with the authentication server, generating a session key associated with the roaming device;
sending the session key to an access point of the network, the session key being encrypted with a second shared code; and
utilizing the session key to authenticate the roaming device at the access point, and to encrypt data exchanged between the roaming device and the access point.

20. The method according to claim 19, further comprising the step of:
sending the encrypted session key to a further access point of the network to authenticate the roaming device at the further access point.

21. The method according to claim 19, further comprising the steps of:
generating a first key of the session key to perform authentication of the roaming device at the access point; and
generating a second key of the session key to encrypt data exchanges between the roaming device and the access point, the second key being different from the first key.
